(19) United States
(12) Patent Application Publication
(10) Pub. No.: US 2026/0330813 A1
(43) Pub. Date: Oct. 22, 2026

(54) METHOD AND DEVICE FOR GENERATING SYNTHETIC ANOMALY IMAGES OF A PRODUCT IN ORDER TO ENRICH A TRAINING DATASET

(71) Applicant: Robert Bosch GmbH, Stuttgart (DE)

(72) Inventors: Ylli Sadikaj, Wien (AT); Lavdim Halilaj, Leonberg (DE); Hongkuan Zhou, Stuttgart (DE); Stefan Schmid, Waiblingen (DE)

(21) Appl. No.: 19/574,558

(22) Filed: Mar. 23, 2026

(30) Foreign Application Priority Data
Mar. 31, 2025 (DE) 10 2025 112 599.6

(51) Int. Cl. G06V 10/774; G06N 5/022; G06V 10/776

(52) U.S. Cl. CPC G06V 10/774; G06N 5/022; G06V 10/776

(57) ABSTRACT

A method for generating synthetic anomaly images of a product to enrich a training dataset for anomaly detection and/or anomaly classification of the product. The method includes: providing a user input that describes a product and at least one associated item of anomaly information; extracting a subgraph from a predefined knowledge graph, wherein the knowledge graph includes relationships between products, their properties and/or possible anomalies, and the subgraph refines and/or constrains the information of the user input in a domain-specific manner; generating a plurality of specific text prompts based on the information of the extracted subgraph; using the generated text prompts to control a previously trained text-to-image generation model to generate synthetic anomaly images of the product; and providing the generated anomaly images to enrich a training dataset for training a machine learning model for anomaly detection and/or anomaly classification.

### FIELD

The present disclosure relates to the technical field of artificial intelligence, in particular machine learning and neural networks with a focus on image generation, anomaly detection and multimodal representation learning. Specifically, the present disclosure relates to a method for generating synthetic anomaly images of a product in order to enrich a training dataset for anomaly detection and/or anomaly classification of the product.

Furthermore, the present disclosure relates to a device for generating synthetic anomaly images of a product in order to enrich a training dataset for anomaly detection and/or anomaly classification of the product.

### BACKGROUND INFORMATION

In recent years, diffusion models have become established as effective approaches to image synthesis and manipulation. In these, a step-by-step transformation process is used to generate high-resolution and realistic images.

A key challenge in this field is the extraction of meaningful and decodable representations of image data in order to efficiently make them usable for various tasks. Research results show that improved image representation can be achieved by using trainable encoders in combination with diffusion models as decoders.

This opens up new possibilities for generative models and their applications in image processing. Furthermore, the use of text-based prompt methods has proven promising in anomaly detection.

The ability to incorporate domain-specific information into the model in a targeted manner can significantly improve performance in various scenarios. Furthermore, the use of multimodal foundation models that combine natural language and image information has set new standards for transferable learning and shows promising approaches for adaptive and generalizable models. Another focus of current research is on the further development of diffusion models, which are now able to achieve higher quality results in image synthesis than previously dominant generative adversarial networks. Probabilistic modeling approaches are used, which are based on weighted variation limits and thus allow more precise control of the image generation.

However, one challenge with these methods is that the generated anomalies often do not reflect the real, domain-specific variations that occur in practical applications. While conventional augmentation methods merely perform simple transformations of existing images, realistic anomaly simulations require a deeper semantic modeling of the underlying structures and interactions within an image. Modern generative models, in particular diffusion models and multimodal systems such as CLIP, offer promising approaches to the more realistic synthesis of anomalies by using both visual and textual information. However, existing methods are often limited in their adaptability to specific product categories or defect patterns, as they are based on generally formulated prompt templates or purely data-driven approaches. The challenge, therefore, is to expand generative models so that they can efficiently integrate domain-specific knowledge and generate realistic, structured anomalies that allow improved training effectiveness for anomaly detection models.

Standardized datasets that allow a realistic assessment of the performance are used to evaluate these models. Comprehensive datasets have been developed, in particular for the field of anomaly detection, to ensure a robust evaluation of the model quality.

On the basis of these developments, a further method is needed that makes it possible to combine the advantages of the different research directions in a targeted and previously unknown way and to make them usable for specific application fields such as anomaly detection and/or image generation with domain-specific requirements.

### SUMMARY

It is an object of the present disclosure to specify a method and/or a device that are improved in this regard.

The object may be achieved by a method according to certain features of the present disclosure. The object is achieved by a device according to certain features.

According to a first aspect, a method is provided for generating synthetic anomaly images of a product in order to enrich a training dataset for anomaly detection and/or anomaly classification of the product. According to an example embodiment, the method comprises the steps of:
providing a user input that describes a product and at least one associated item of anomaly information,
extracting a subgraph from a predefined knowledge graph, wherein the knowledge graph comprises relationships between products, their properties and/or possible anomalies, and the subgraph refines and/or constrains the information of the user input in a domain-specific manner,
generating a plurality of specific text prompts on the basis of the information of the extracted subgraph,
using the generated text prompts to control a previously trained text-to-image generation model to generate synthetic anomaly images of the product, wherein the generation preferably also takes place on the basis of a non-anomalous product image, and
providing the generated anomaly images in order to enrich a training dataset for training a machine learning model for anomaly detection and/or anomaly classification.

It is understood that the steps according to the present disclosure, as well as other optional steps, do not necessarily have to be executed in the order shown, but can also be executed in a different order. Other intermediate steps can also be provided. The individual steps can also comprise one or more sub-steps without departing from the scope of the method according to the present disclosure.

According to a second aspect, a device is provided for generating synthetic anomaly images of a product in order to enrich a training dataset for anomaly detection and/or anomaly classification of the product. According to an example embodiment, the device comprises:
an input unit that is configured to acquire a user input that describes a product and at least one associated item of anomaly information,
a processing unit that is configured to extract a subgraph from a predefined knowledge graph, wherein the knowledge graph comprises relationships between products, their properties and/or possible anomalies, and the subgraph refines and/or constrains the information of the user input in a domain-specific manner,
a generation unit that is configured to generate a plurality of specific text prompts on the basis of the information of the extracted subgraph,
an image synthesis unit that is configured to use the generated text prompts to control a previously trained text-to-image generation model to generate synthetic anomaly images of the product, wherein the generation preferably also takes place on the basis of a non-anomalous product image, and
an output unit that is configured to provide the generated anomaly images in order to enrich a training dataset for anomaly detection and/or anomaly classification.

The explanations given for the method apply accordingly to the device. It is understood that linguistic modifications of features formulated for the method can be reformulated for the device in accordance with standard linguistic practice, without such formulations having to be explicitly listed here.

The method preferably comprises providing a user input that describes a product and at least one associated item of anomaly information. This preferably makes it possible to generate specific defect images for the product in question, thereby allowing targeted enrichment of the training dataset. A further feature is preferably the extraction of a subgraph from a predefined knowledge graph, wherein the knowledge graph preferably comprises relationships between products, their properties and possible anomalies. The subgraph is preferably used to refine and/or constrain the information of the user input in a domain-specific manner, thereby ensuring that the generated data represent relevant and realistic anomalies. This preferably improves data quality and avoids the generation of implausible anomaly images.

A further feature is preferably the generation of a plurality of specific text prompts on the basis of the information of the extracted subgraph. These text prompts are preferably used to control the subsequent generation model in a targeted manner and to allow more precise image synthesis. The text prompts preferably comprise detailed descriptions of the product features and the relevant anomalies and allow more precise control of the image generation. It is technically advantageous here that the structured generation of prompts ensures a consistent quality of the generated images.

The text-to-image generation model is preferably used to synthesize realistic anomaly images on the basis of the generated prompts by converting the textual information into visual representations. Preferably, the generation is also carried out taking into account a non-anomalous product image, which ensures that the generated anomaly images are consistent with the original product properties. One advantage of this method is preferably that it allows a greater variety of anomaly images that still remain realistic and are suitable for training machine learning models.

The synthetically generated images are preferably combined with existing training data to increase model robustness and allow better generalizability of the anomaly detection. The technical advantage lies preferably in the improved data availability for the training, in particular in scenarios where real anomaly images are scarce or difficult to acquire. The combination of real and synthetic data preferably leads to more effective and reliable anomaly detection.

Therefore, an approach is proposed here that utilizes the prior knowledge about the field (e.g., realistic anomalies in a product). The prior knowledge is preferably represented by a knowledge graph (KG) in order to generate, preferably automatically, more meaningful text prompts for image generation with regard to the task of anomaly detection. In the proposed approach, the knowledge graph for anomalies (KGA) is formed, which preferably represents the relationships between each entity (product) and the corresponding anomalies with the respective properties (attributes). Instead of using manually created text prompts, the created knowledge graph is used as a template to automatically generate the text prompts for realistic product anomalies, preferably taking into account the constraints (properties) of each product and each anomaly.

In the present case, image data of products with and without anomalies are preferably used to create a knowledge graph ontology regarding products, product defects and their relationships. To create the most realistic text prompt possible that describes specific anomalies for a product, a related subgraph is preferably extracted from the constructed knowledge graph. A focus can be placed on target anomalies and the product. The model pipeline proposed in the present case can use the previously trained and fine-tuned base model CLIP or any other vision language base model. In the present case, a base model is thus trained using the knowledge graph to create text prompts, in order to generate more realistic images, in particular in the context of anomaly detection. Preferably, the constructed text prompt from the knowledge graph is used first to optimize the model.

Furthermore, the method can comprise a step for generating images in which a guided diffusion model is trained for image generation. Preferably, the constructed text prompt from the knowledge graph and product images without anomalies are used. The base model can be trained on synthetic datasets for anomaly detection. The goal of this training is to develop a deep understanding of the generation of text prompts that are used to create realistic defect images. These images support training and improve the performance of downstream tasks such as anomaly detection, object recognition and/or image segmentation. The present approach focuses on controlling the image generation process by a diffusion model by means of text prompts.

Instead of creating these text prompts manually, a knowledge graph is used to automate the acquisition of domain-specific and meaningful prompts for generating defective product images. This eliminates the manual, error-prone process of defining text prompts on the basis of user inputs. Instead, prompts are automatically derived from the knowledge graph for anomalous products.

The developed approach “Knowledge Graphs for Image Generation (KG4IG)” consists of a base model that uses the knowledge graph to create text prompts for image generation. This allows improved anomaly detection and can be optimized for specific tasks or used as a supplementary source of knowledge. The model can verify facts and retrieve precise information about a specific field-a crucial factor for applications in which the accuracy and reliability of information are essential, for example in the detection of anomalies in production processes.

A further problem with many applications is the specialized terminology, which is often not sufficiently understood by general models. However, by integrating a knowledge graph, the model can acquire these terms and use them consistently to generate appropriate text prompts. This reduces the risk of ambiguous or erroneous prompts and improves the quality of the generated anomaly images for different product classes.

The approach can be seamlessly integrated into existing systems and workflows and thus offers increased efficiency and improved functionality. Furthermore, it allows the structuring of information at a high level between products and their anomaly properties, for example in terms of location, shape or size.

This structured information is used to train more effective base models for understanding anomalies in image generation.

The described method comprises the learning of representations using diffusion models and the use of complex multimodal latent spaces for image generation. It is also shown how user guidance through text prompts can be integrated into the generation of images for anomaly detection. A key element is the development of a knowledge graph for product anomalies, which is used to generate text prompts and to train the base model for generating realistic anomaly images. This significantly contributes to the improvement in the accuracy of anomaly detection tasks.

In another aspect, it is provided that the text-to-image generation model comprises a text-based encoder for processing the generated text prompts and a diffusion model for image synthesis, wherein the text-based encoder creates a multimodal representation of the text prompts, and this is used to control the image generation in the diffusion model.

The text-based encoder is preferably used to convert the text information into a representation understandable to the model, thereby ensuring a structured and coherent interpretation of the inputs. A technical advantage preferably consists in that the model allows more precise image generation in this way, since the text-based information is converted into a high-dimensional, machine-readable form.

A diffusion model is preferably a generative model that incrementally adds noise to an image and then learns the reverse process to generate realistic images from noisy inputs. This method preferably makes it possible to generate high-resolution and consistent image data that exhibit improved quality in comparison with other generative models.

The text-based encoder preferably creates a multimodal representation of the text prompts. Multimodal representations preferably integrate information from different modalities, in this case text and image, to allow a coherent and context-aware representation of the inputs. The technical advantage lies preferably in the fact that the model does not only rely on pure text information but can link it with existing visual features to improve the generation of realistic anomaly images.

This multimodal representation is preferably used to control image generation in the diffusion model. This preferably means that the previously processed text information is used to guide the image generation process in a targeted manner so that the generated anomaly images correspond to the properties described in the text prompt. A technical advantage is preferably that the image generation process can thereby be made more flexible and precise, since the generated images do not arise randomly but are controlled in a targeted manner to achieve the most realistic possible representation of the anomalies.

In a further aspect, it is provided that the predefined knowledge graph comprises an ontology that describes products, their properties and anomalies, and is constrained by axioms and rules so that the generated text prompts do not violate any defined constraints.

The predefined knowledge graph preferably comprises an ontology that describes products, their properties, and anomalies. An ontology preferably represents a formalized knowledge structure that makes it possible to logically define and store relationships between entities. The technical advantage lies preferably in the fact that the structured representation of domain knowledge creates a consistent and interpretable basis for generating text prompts.

The knowledge graph is preferably constrained by axioms and rules. Axioms preferably define fundamental truths within the ontology and prevent contradictory or erroneous data. Rules are preferably used to draw logical inferences from existing information and thus expand the database. The advantage lies preferably in the fact that it is thereby ensured that all generated text prompts follow a consistent and valid knowledge structure and that no illogical or contradictory inputs are generated.

The generated text prompts preferably do not violate any defined constraints. This preferably means that the knowledge graph automatically checks whether a generated text prompt matches the defined product information and anomaly information. A technical advantage lies preferably in the fact that erroneous and/or implausible inputs are thereby avoided, as a result of which the quality of the generated synthetic anomaly images is improved.

In a further aspect, it is provided that a subgraph extractor is used that takes the user input into account and, on the basis of the predefined knowledge graph, ascertains additional derived information about product properties and anomalies in order to semantically enrich the generated text prompts.

The subgraph extractor is preferably used to take the user input into account. The subgraph extractor is preferably used to extract the information that is relevant to the specific user input in a targeted manner from the entire knowledge structure of the predefined knowledge graph. The technical advantage lies preferably in the fact that it allows a targeted and efficient selection of relevant product and anomaly data, thereby optimizing the generation of text prompts.

The subgraph extractor preferably ascertains additional derived information about product properties and anomalies on the basis of the predefined knowledge graph. This derived information preferably results from logical inferences within the ontology and allows further specification of the text prompts.

The generated text prompts are preferably enriched semantically. This preferably means that the extractor not only provides raw information but also converts it into a context-related and understandable linguistic expression. Semantic enrichment results in more precise text prompts that can be interpreted better and in turn improve the quality of the anomaly images generated by the generative model.

In a further aspect, it is provided that the generated anomaly images are used to fine-tune a previously trained machine learning model by training the model by means of a contrastive learning objective using the synthetic anomaly images and the associated text prompts, so that the similarity between corresponding images and text prompts is maximized and the similarity between non-corresponding images and text prompts is minimized.

The generated anomaly images are preferably used to fine-tune a previously trained machine learning model. The fine-tuning of a model preferably describes the adaptation of an already trained model to specific tasks and/or datasets by further training it with additional, domain-specific data. This optimizes the model for more precise detection of anomalies by enriching it in a targeted manner with synthetic anomaly images containing realistic product defects.

The model is preferably trained by means of a contrastive learning objective using the synthetic anomaly images and the associated text prompts. Contrastive learning is preferably a method of machine learning in which similarities between corresponding data pairs are maximized and similarities between non-corresponding data pairs are minimized. The model thereby learns to establish strong relationships between an anomaly image representation and the corresponding text description, which improves the semantic coherence and precision of the anomaly detection.

The similarity is preferably maximized between corresponding images and text prompts and is minimized between non-corresponding images and text prompts. This preferably means that the model is optimized during training to reinforce correct pairs of anomaly images and their descriptions, while deliberately distinguishing between incorrect pairings.

In a further aspect, it is provided that the generated synthetic anomaly images comprise a bounding box, which is defined by coordinate values and describes the position, size and/or shape of the anomaly within the image, so that the bounding box can be used to locate the anomaly in downstream anomaly detection tasks and classification tasks.

The generated synthetic anomaly images preferably comprise a bounding box defined by coordinate values. A bounding box is preferably a rectangular region in an image that is used to mark a specific object or feature. It is preferably characterized by (x, y) coordinates that define the starting point of the rectangle or square, and by values for height and width that define the size of the region. The bounding box makes it possible to precisely locate anomalies and to prepare the training data in a targeted manner for models that rely on both pixel-accurate and object-specific defect analyses.

The bounding box preferably describes the position, size and/or shape of the anomaly within the image. This preferably means that not only the location of an anomaly in the image is acquired, but also the geometric properties of the anomaly, which are necessary for defect evaluation.

The bounding box is preferably used to locate the anomaly in downstream anomaly detection tasks and classification tasks. This preferably allows machine learning models to focus in a targeted manner on the relevant image regions and to waste fewer resources on non-anomalous regions in the image. The technical advantage lies preferably in the fact that the efficiency and accuracy of anomaly detection systems are improved by directing the model capacities in a targeted manner to the identified defect regions. In a further aspect, it is provided that a method for training a machine learning model for anomaly detection and/or anomaly classification is provided, comprising the steps of:
providing a training dataset that comprises synthetic anomaly images of a product and non-anomalous product images, wherein the synthetic anomaly images are generated according to one of the aforementioned aspects,
training a machine learning model using the training dataset, wherein the machine learning model is optimized to distinguish between normal and anomalous products and to detect and/or classify anomalies, and
optionally validating the trained machine learning model using a separate test dataset to evaluate the detection and classification performance of the model, wherein the test dataset preferably comprises synthetic anomaly images of a product and non-anomalous product images, wherein the synthetic anomaly images are generated according to one of the aforementioned aspects.

The machine learning model is preferably trained using the training dataset, wherein it is optimized to distinguish between normal and anomalous products and to detect and/or classify anomalies. This preferably means that the model learns the properties of defective and defect-free products and is able to detect and categorize new anomalies during the inference phase.

The trained machine learning model can preferably optionally be validated using a separate test dataset. Therefore, after the training phase, an additional evaluation of the model performance is preferably carried out to ensure that the model generalizes and makes robust predictions. The technical advantage lies preferably in the fact that, by means of the validation, potential overfitting can be identified, and the model can be optimized before it is used in a production environment.

The test dataset preferably comprises synthetic anomaly images of a product and non-anomalous product images, wherein the synthetic anomaly images are generated according to one of the aforementioned aspects. This preferably ensures that the model is tested with a realistic distribution of anomalies and that its predictive capability can be verified under conditions close to practice.

A further aspect concerns the structured representation of products and anomalies within the predefined knowledge graph (KGA), which makes it possible to identify not only explicit but also derived relations between the entities. In this process, inference algorithms are used to generate new relation types, which are preferably not directly defined in the KGA but can be logically derived from existing relationships. This allows a more comprehensive modeling of the relationships between product types, defect types, and specific anomaly characteristics. By means of these expanded relations, the model can thereby acquire not only known but also potential new defect types and use them to generate text prompts.

Additionally, the knowledge graph is preferably used to validate the generated input prompts by defining constraints that prevent the creation of invalid and/or implausible combinations of product properties and anomalies. For example, a rule can specify that the color of an augmentation must not match the original color of the product and/or that a specific product type can only have certain defect types. These constraints ensure that the generated text prompts correspond to the physical and technical conditions of the respective products. This leads to improved quality and consistency of the synthetic anomaly images and increases the efficiency of the subsequent anomaly detection.

Furthermore, the extracted substructure of the knowledge graph preferably allows the targeted generation of text prompts that concentrate on specific properties of a product and its possible anomalies. This preferably also comprises the acquisition of features such as anomaly size, position and/or shape, as well as suitable augmentation techniques for simulating realistic defects. The structured derivation of this information ensures that the generated synthetic anomaly images are not only of high quality, but also optimized for the specific training requirements of anomaly detection models. These additional mechanisms help to increase the effectiveness of the entire method by allowing a coherent and controlled generation of training data.

In a further aspect, a control unit is also provided, which is included in a vehicle having an autonomous driving function, and/or a robotic system and/or an industrial machine and on which the present method can be carried out in one of its aspects.

In a further aspect, a computer program having program code is provided for executing at least parts of the present method in one of its aspects when the computer program is executed on a computer. In other words, a computer program (product) comprises instructions which, when the program is executed by a computer, causes the computer to execute the method/the steps of the method in one of its aspects.

In a further aspect, a computer-readable data carrier having program code of a computer program is provided for executing at least parts of the present method in one of its aspects when the computer program is executed on a computer. In other words, the present disclosure relates to a computer-readable (memory) medium comprising instructions which, when executed by a computer, cause the computer to execute the method/the steps of the method in one of its aspects.

The present disclosure preferably relates to the processing and analysis of image data acquired with a sensor camera. It preferably offers a versatile solution for use in various fields of machine learning, in particular in image generation and image augmentation to support computer vision tasks. One field of application of the present disclosure is preferably the generation of synthetic image datasets that can be used to train machine learning systems for tasks such as anomaly detection, anomaly classification, image segmentation and anomaly segmentation. The generation of such datasets can preferably help to improve the training of models, in particular in cases in which the available real-world data are limited or unbalanced. Furthermore, the present disclosure can be used to expand existing training datasets through image augmentation. This can preferably be achieved either by the generation of new synthetic images or by the targeted modification of existing images to increase the diversity of the training data and improve the robustness of the trained models.

A further aspect of the present disclosure is its use in the field of active learning and testing of machine learning systems. It preferably allows the targeted selection of suitable data points both for the training and for the validation, verification and evaluation of ML systems. In particular, the present disclosure can be used to generate suitable training data that allow effective model optimization. Furthermore, the present disclosure can be used to create test and validation datasets that allow the performance and reliability of a trained model to be comprehensively checked. Another feature of the present disclosure is its ability to serve as a method for training generative models. After the training phase, these can preferably be used for various applications in image processing, including the generation of images for training other models or the direct use of the generated images in computer vision systems. The versatility of the present disclosure makes it a tool for the entire life cycle of machine learning systems, from data generation and model training to evaluation and optimization of the trained models.

The described embodiments and developments can be combined with one another as desired.

Further possible embodiments, developments and implementations of the present disclosure also include combinations not explicitly mentioned of features of the present disclosure described above or in the following relating to the exemplary embodiments.

### BRIEF DESCRIPTION OF THE DRAWINGS

The figures are intended to impart further understanding of the embodiments of the present disclosure. They illustrate embodiments and, in connection with the description, serve to explain principles and concepts of the present disclosure.

Other embodiments and many of the mentioned advantages are apparent from the figures. The illustrated elements of the figures are not necessarily shown to scale relative to one another.

FIG. 1 is a schematic flow chart of an exemplary embodiment of the present method.

FIG. 2 is a schematic view of an exemplary knowledge graph.

FIG. 3 is an example of the use of a knowledge graph and the relationships derived from it.

FIG. 4 is an overview of the structure presented here.

FIG. 5 is a schematic view of a device according to an embodiment.

### DETAILED DESCRIPTION OF EXAMPLE EMBODIMENTS

In the figures, identical reference signs denote identical or functionally identical elements, parts or components, unless stated otherwise.

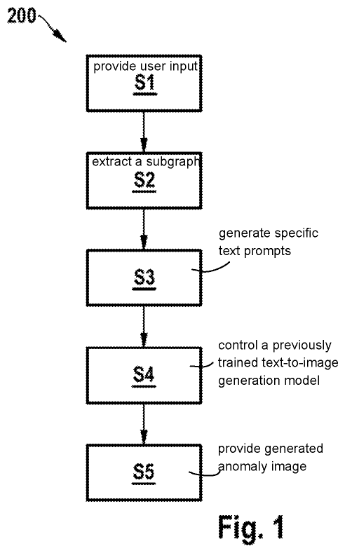

FIG. 1 shows a schematic flow chart of a method 200 for generating synthetic anomaly images of a product in order to enrich a training dataset for anomaly detection and/or anomaly classification of the product.

In any embodiment, at least part of the method 200 can be carried out by a device 300. The device 300 can be a part of a system.

The computer-implemented method 200 comprises at least the following steps:

In a step S1, a user input 202 is provided, which describes a product and at least one associated item of anomaly information.

In a step S2, a subgraph 204 is extracted from a predefined knowledge graph 206 by means of a subgraph extractor 205 on the basis of a user preference contained in the user input 202, wherein the knowledge graph 206 comprises relationships between products, their properties and/or possible anomalies, and the subgraph 204 refines and/or constrains the information of the user input 202 in a domain-specific manner.

In a step S3, a plurality of specific text prompts 208 are generated by means of a text prompt generator 209 on the basis of the information of the extracted subgraph 204.

In a step S4, the generated text prompts 208 are used to control a previously trained text-to-image generation model 210 to generate synthetic anomaly images 212 of the product, wherein the generation preferably also takes place on the basis of a non-anomalous product image 214.

In a step S5, the generated anomaly images 212 are provided in order to enrich a training dataset 216 for training a machine learning model 218 for anomaly detection and/or anomaly classification.

The text-to-image generation model 210 uses a combination of a text-based encoder 220 and a diffusion model 222 to control the image synthesis. The text-based encoder 220 is configured to process the generated text prompts and to generate a multimodal representation 224 of the inputs. This multimodal representation 224 integrates both the semantic meaning of the text prompts and context-related information from the predefined knowledge graph 206, thus allowing targeted control of the image generation.

The diffusion model 222 is designed such that it generates the synthetic anomaly images 212 on the basis of the multimodal representation 224. A step-by-step conversion process is used in which, by taking noise 226 into account, a highly noisy image is generated first and is successively converted into a realistic anomaly image 212. By means of this method, the device 300 can generate high-resolution and detailed defect images, which are characterized by a realistic representation of the anomalies.

The use of the text-based encoder 320 in conjunction with the diffusion model 322 offers the technical advantage that the generated images are not limited to simple visual features, but can also represent complex, semantically based anomalies. The device 300 can therefore create realistic and domain-specific defect images, which are particularly relevant for training anomaly detection models. In addition, the processing unit 302 of the device 300 can optimize the quality of the generated text prompts by means of an adaptive learning process, so that the entire image generation process can be iteratively improved.

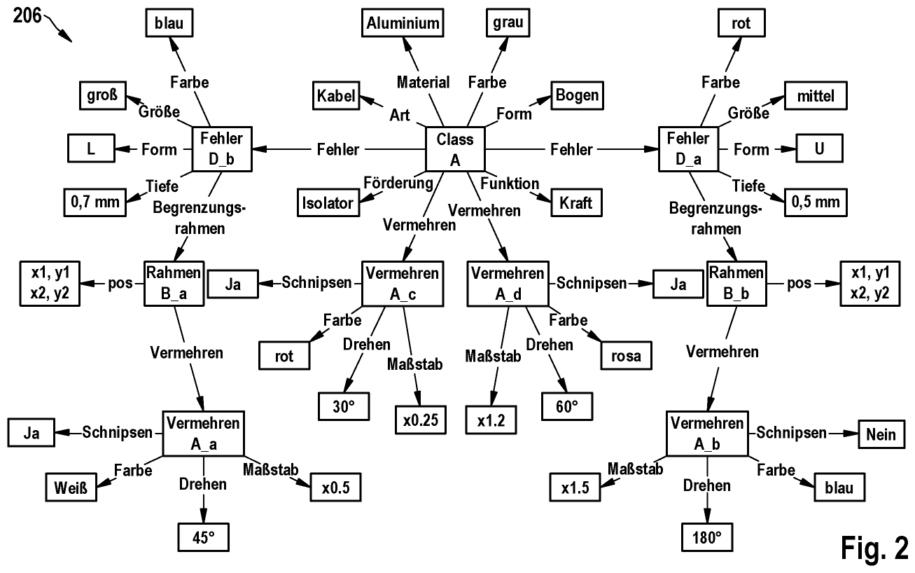

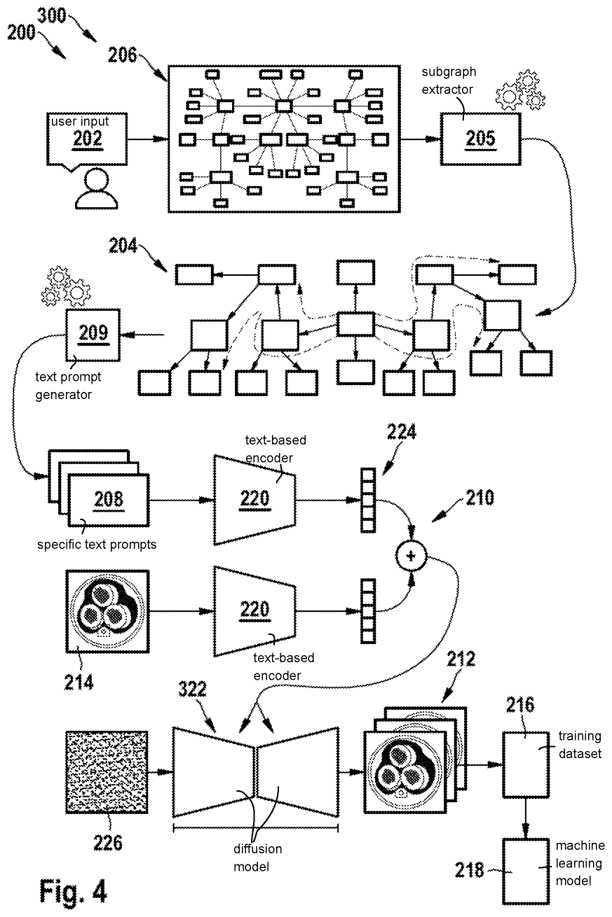

Further details of the individual steps of the method 200 are described with reference to FIG. 2 to 5, which show different embodiments and technical details of the method steps. These figures show in particular structural and functional aspects of the knowledge graph 206, the extraction of the subgraph 204, and the generation of the specific text prompts 208 and their use in the text-to-image generation model 210. Furthermore, the figures show various possible implementation variants and processing methods within the device 300 that is used to carry out the method 200.

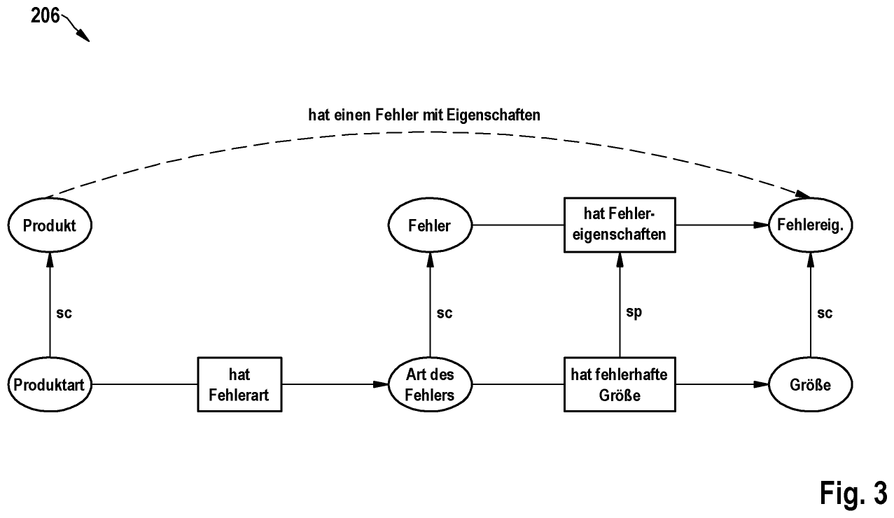

FIG. 3 shows a structure of the knowledge graph 206 for product anomalies, which shows how different concepts and their relations can be formalized. FIG. 3 visualizes the relationship, in particular the hierarchical relationship, between products, defects and their characteristics, as well as derived relationships within the ontology.

The left-hand region of FIG. 3 shows the concept “Product,” which forms a higher-level class for “Product Type.” This relationship is denoted by sc (subclass), which indicates that product types can be specific instances or categories of the general product concept. A product type can be assigned a defect type via the “hasDefectType” relation, by means of which it is specified which anomalies can occur for a particular product.

The defect type is in turn a subclass (sc) of the general defect concept. It follows from this that all specific defect types fall under the general concept of defects. A defect can be further defined by its properties, which are linked to the concept of “Defect Characteristics” via the relation “hasDefectCharacteristics.” These defect characteristics, such as the size of an anomaly, are specified via a further relation “hasDefectSize,” which is a sub-property (sp) of “hasDefectCharacteristics.” The defect size is ultimately associated with an entity “Size,” which is also characterized as a subclass (sc) of “Defect Characteristics.” An important aspect of this figure is the dashed connection “hasDefectWithCharacteristics,” which represents a derived relation. This shows that a product is not only associated with a defect, but that this defect also has specific characteristics, as a result of which a direct relationship is established between “Product” and “Defect Characteristics.” This new relation can preferably be derived automatically by means of a subgraph extractor 205, as a result of which relationships that are not explicitly modeled but logically present can be recognized.

This ontology-based modeling makes it possible to build the knowledge graph in a structured manner in order to use it in generating text prompts for the image synthesis. The defined axioms of the KGA ensure that only meaningful and consistent relationships between products and their anomalies are included in the anomaly image generation. This helps to improve the quality and realism of the generated synthetic images while simultaneously ensuring that no contradictory or erroneous text prompts are generated.

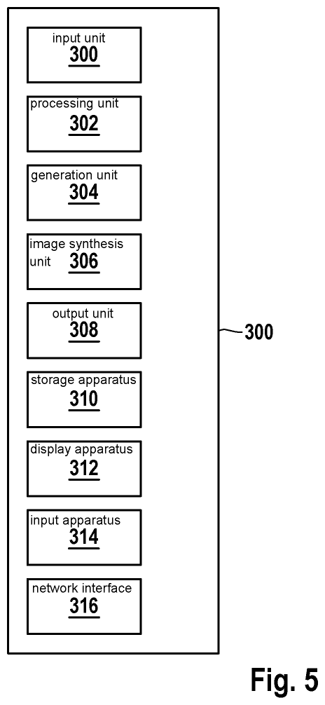

With reference to FIG. 5, the device 300 for generating synthetic anomaly images of a product in order to enrich a training dataset for anomaly detection and/or anomaly classification of the product is shown, which device can be used in any embodiment to carry out at least part of the method 200. For this purpose, the device 300 comprises a plurality of functional units, including an input unit 300 that is configured to acquire a user input that describes a product and at least one associated item of anomaly information. Furthermore, the device 300 comprises a processing unit 302 that is configured to extract a subgraph from a predefined knowledge graph, wherein the knowledge graph comprises relationships between products, their properties and/or possible anomalies.

The subgraph refines and/or constrains the information of the user input in a domain-specific manner to allow targeted and consistent generation of anomaly images.

For further processing, a generation unit 304 is provided, which is configured to generate a plurality of specific text prompts on the basis of the information of the extracted subgraph. These text prompts are used as control parameters for the subsequent image synthesis. For this purpose, the device 300 comprises an image synthesis unit 306 that is configured to use the generated text prompts to control a previously trained text-to-image generation model. The image synthesis unit 306 generates synthetic anomaly images of the product, wherein the generation preferably also takes place on the basis of a non-anomalous product image to ensure a realistic representation of the anomalies.

The generated anomaly images are then provided via an output unit 308 to enrich the training dataset for a machine learning model for anomaly detection and/or anomaly classification.

Additionally, the device 300 can comprise a storage apparatus 310, which is used to store the generated anomaly images as well as the associated metadata and training information.

The device 300 can also have a display apparatus 312 and an input apparatus 314, which allow a user to check the acquired inputs, make adjustments and validate the generated image material. These interfaces improve the monitoring and quality assurance of the method by allowing interactive adjustment of the parameters to optimize the synthetic anomaly images.

Additionally, the device 300 can be integrated into a larger system comprising a plurality of such devices to allow parallel processing and efficient scaling of the image generation. In such a system, the device 300 can be connected to further processing units that, for example, carry out continuous optimization of the knowledge graph structure and text prompts on the basis of the insights gained in the training process.

The device 300 can also have a network interface 316, which allows communication with external data sources or further AI models to ensure continuous expansion and improvement of the training dataset. This expansion ensures that the generated anomaly images always correspond to current defect images and industrial requirements, as a result of which the efficiency and accuracy of anomaly detection models are further improved.

A method for generating synthetic anomaly images of a product to enrich a training dataset for anomaly detection and/or anomaly classification of the product. The method includes: providing a user input that describes a product and at least one associated item of anomaly information; extracting a subgraph from a predefined knowledge graph, wherein the knowledge graph includes relationships between products, their properties and/or possible anomalies, and the subgraph refines and/or constrains the information of the user input in a domain-specific manner; generating a plurality of specific text prompts based on the information of the extracted subgraph; using the generated text prompts to control a previously trained text-to-image generation model to generate synthetic anomaly images of the product; and providing the generated anomaly images to enrich a training dataset for training a machine learning model for anomaly detection and/or anomaly classification.

1. A method (200) for generating synthetic anomaly images (212) of a product in order to enrich a training dataset (216) for anomaly detection and/or anomaly classification of the product, comprising the steps of:
providing a user input (202) that describes a product and at least one associated item of anomaly information,
extracting a subgraph (204) from a predefined knowledge graph (206), wherein the knowledge graph (206) comprises relationships between products, their properties and/or possible anomalies, and the subgraph (204) refines and/or constrains the information of the user input (202) in a domain-specific manner,
generating a plurality of specific text prompts (208) on the basis of the information of the extracted subgraph (204),
using the generated text prompts (208) to control a previously trained text-to-image generation model (210) to generate synthetic anomaly images (212) of the product, wherein the generation preferably also takes place on the basis of a non-anomalous product image (214), and
providing the generated anomaly images (212) in order to enrich a training dataset (216) for training a machine learning model (218) for anomaly detection and/or anomaly classification.

2. The method according to claim 1, wherein the text-to-image generation model (210) comprises a text-based encoder (220) for processing the generated text prompts (208) and a diffusion model (222) for image synthesis, wherein the text-based encoder (220) creates a multimodal
representation (224) of the text prompts (208), and this is used to control the image generation in the diffusion model (222).

3. The method according to claim 1 or 2, wherein the predefined knowledge graph (206) comprises an ontology that describes products, their properties and anomalies, and is constrained by axioms and rules so that the generated text prompts (208) do not violate any defined constraints.

4. The method according to one of claims 1 to 3, wherein a subgraph extractor (205) is used which takes the user input (202) into account and, on the basis of the predefined knowledge graph (206), ascertains additional derived information about product properties and anomalies in order to semantically enrich the generated text prompts (208).

5. The method according to one of claims 1 to 4, wherein the generated anomaly images (212) are used to fine-tune a previously trained machine learning model (218) by training the model by means of a contrastive learning objective using the synthetic anomaly images (212) and the associated text prompts (208), so that the similarity between corresponding images (212) and text prompts (208) is maximized and the similarity between non-corresponding images and text prompts is minimized.

6. The method according to one of claims 1 to 5, wherein the generated synthetic anomaly images (212) comprise a bounding box, which is defined by coordinate values and describes the position, size and/or shape of the anomaly within the image (212), so that the bounding box can be used to locate the anomaly in downstream anomaly detection tasks and classification tasks.

7. A method for training a machine learning model (218) for anomaly detection and/or anomaly classification, comprising the steps of:
providing a training dataset (216) that comprises synthetic anomaly images (212) of a product and non-anomalous product images (214), wherein the synthetic anomaly images (212) are generated by a method according to one of claims 1 to 6,
training a machine learning model (218) using the training dataset (216), wherein the machine learning model (218) is optimized to distinguish between normal and anomalous products and to detect and/or classify anomalies, and
optionally validating the trained machine learning model (218) using a separate test dataset to evaluate the detection and classification performance of the model (218), wherein the test dataset preferably comprises synthetic anomaly images (212) of a product and non-anomalous product images (214), wherein the synthetic anomaly images (212) are generated by a method according to one of claims 1 to 6.

8. A computer program having program code in order to execute at least parts of a method according to one of claims 1 to when the computer program is executed on a computer.

9. A computer-readable data carrier having program code of a computer program in order to execute at least parts of a method according to one of claims 1 to 7 when the computer program is executed on a computer.

10. A device (300) for generating synthetic anomaly images (212) of a product in order to enrich a training dataset (216) for anomaly detection and/or anomaly classification of the product, comprising:
an input unit (300) that is configured to acquire a user input (202) that describes a product and at least one associated item of anomaly information,
a processing unit (302) that is configured to extract a subgraph (204) from a predefined knowledge graph (206), wherein the knowledge graph (206) comprises relationships between products, their properties and/or possible anomalies, and the subgraph (204) refines and/or constrains the information of the user input (202) in a domain-specific manner,
a generation unit (304) that is configured to generate a plurality of specific text prompts (208) on the basis of the information of the extracted subgraph (204),
an image synthesis unit (306) that is configured to use the generated text prompts (208) to control a previously trained text-to-image generation model (210) to generate synthetic anomaly images (212) of the product, wherein the generation preferably also takes place on the basis of a non-anomalous product image (214), and
an output unit (308) that is configured to provide the generated anomaly images (212) to enrich a training dataset (216) for anomaly detection and/or anomaly classification.
